(19) United States
(12) Patent Application Publication
(10) Pub. No.: US 2020/0086371 A1
(43) Pub. Date: Mar. 19, 2020

(54) METHOD OF MANUFACTURING CASE FOR STARTING DEVICE, AND CASE FOR STARTING DEVICE

(71) Applicant: AISIN AW CO., LTD., Anjo-shi, Aichi-ken (JP)

(72) Inventors: Akihiro NAGAE, Anjo (JP); Akiyoshi OTSUKI, Anjo (JP); Shuhei HASHIGUCHI, Nishio (JP)

(73) Assignee: AISIN AW CO., LTD., Anjo-shi, Aichi-ken (JP)

(21) Appl. No.: 16/470,600

(22) PCT Filed: Mar. 30, 2018
(86) PCT No.: PCT/JP2018/013914

§ 371 Date: Jun. 18, 2019

(30) Foreign Application Priority Data
Mar. 30, 2017 (JP) 2017-067409

(51) Int. Cl. B21D 22/26; B21D 53/88; F16H 41/28; B21D 22/02; B21D 22/22; B21D 5/01; B21D 24/04; F16H 45/02

(52) U.S. Cl. CPC B21D 22/26; B21D 53/88; F16H 41/28; F16H 45/02; B21D 22/22; B21D 5/01; B21D 24/04; B21D 22/02

(57) ABSTRACT

A method of manufacturing a case for a starting device, the case having at least one curved portion and having an interior configured to be supplied with oil includes forming a thickened portion by partially thickening a metal sheet material and forming the curved portion by bending the sheet material at the thickened portion by press working. An outer surface of the curved portion projects outward of the case beyond a curved surface that is concentric with an inner surface of the curved portion and that has a radius of curvature equal to the sum of the radius of curvature of the inner surface and the thickness of the sheet material forming the case. Metal flows in the curved portion are continuous from the inner surface to the outer surface without any break.

### CROSS REFERENCE TO RELATED APPLICATIONS

This application is a National Stage of International Application No. PCT/JP2018/013914 filed Mar. 30, 2018, claiming priority based on Japanese Patent Application No. 2017-067409 filed Mar. 30, 2017.

### TECHNICAL FIELD

The aspects of the present disclosure relate to a method of manufacturing a case for a starting device from a metal sheet material, and a case for a starting device.

### BACKGROUND ART

Conventionally, a starting device (a torque converter) including a front cover, a fluid coupling, a lockup piston, a damper, and a turbine hub is known (for example, refer to Patent Document 1). In this starting device, an outer peripheral portion of a one-side surface of the lockup piston is provided with a circumferentially-disposed friction material to be pressed against an other-side surface of the front cover. Further, an annular sliding member that is made of cast iron and that slides relative to the friction material is joined by brazing on its entire surface to a facing surface of the front cover that faces the friction material. This inhibits a reduction in stiffness of the front cover and thus inhibits deformation of the front cover due to input from an engine.

### RELATED ART DOCUMENTS

### Patent Documents

Patent Document 1: Japanese Patent Application Publication No. 2012-211707 (JP 2012-211707 A)

### SUMMARY OF THE APPLICATION

However, although the conventional starting device may inhibit a reduction in stiffness of the front cover, joining the sliding member made of cast iron to the front cover increases the total weight of the device. One possible way to increase the stiffness of the front cover while restraining an increase in the weight may be to increase the thickness of a sheet material that forms the front cover and to remove unnecessary portions thereof by grinding, but performing grinding in this way increases the manufacturing cost.

For this reason, one purpose of the present disclosure is to increase the stiffness of a case for a starting device while restraining increases in weight and cost.

A method of manufacturing a case for a starting device according to the present disclosure is a method of manufacturing a case for a starting device, the case having at least one curved portion and having an interior configured to be supplied with oil, and includes the following: forming a thickened portion by partially thickening a metal sheet material; and forming the curved portion by bending the sheet material at the thickened portion by press working.

The method according to the present disclosure is capable of forming the curved portion of the case for the starting device such that an outer surface of the curved portion projects outward of the case beyond a curved surface that is concentric with an inner surface of the curved portion and that has a radius of curvature equal to the sum of the radius of curvature of the inner surface and the thickness of the sheet material forming the case, and such that metal flows are continuous from the inner surface to the outer surface without any break. This allows the curved portion to be thickened so as to serve as a rib, without performing grinding that causes an increase in cost, thus increasing the

stiffness of the case for the starting device to which torque is transmitted from a motor and to which centrifugal hydraulic pressure is applied. This makes it possible to select the thickness of the sheet material that forms the case according to portions that do not require high stiffness, and thus to restrain an increase in cost and an increase in weight of the case. Therefore, it is possible to increase the stiffness of the case for the starting device while restraining increases in the weight and cost.

A case for a starting device according to the present disclosure is a case for a starting device, the case being formed from a metal sheet material, having at least one curved portion, and having an interior configured to be supplied with oil, in which an outer surface of the curved portion projects outward of the case beyond a curved surface that is concentric with an inner surface of the curved portion and that has a radius of curvature equal to the sum of a radius of curvature of the inner surface and the thickness of the sheet material forming the case, and metal flows in the curved portion are continuous from the inner surface to the outer surface without any break.

The curved portion included in the case for the starting device is thickened such that the outer surface projects outward of the case beyond the curved surface that is concentric with the inner surface of the curved portion and that has a radius of curvature equal to the sum of a radius of curvature of the inner surface and the thickness of the sheet material forming the case. This allows the curved portion to serve as a rib, thus increasing the stiffness of the case for the starting device to which torque is transmitted from a motor and to which centrifugal hydraulic pressure is applied. Further, the curved portion is formed such that metal flows are continuous from the inner surface to the outer surface without any break. That is, since the curved portion is formed by thickening only a necessary portion of the case, without performing grinding that causes an increase in cost, the curved portion itself has high stiffness. This makes it possible to select the thickness of the sheet material that forms the case according to portions that do not require high stiffness, and thus to restrain an increase in cost and an increase in weight of the case. Therefore, it is possible to increase the stiffness of the case for the starting device while restraining increases in the weight and cost.

### BRIEF DESCRIPTION OF THE DRAWINGS

FIG. 1 is a schematic diagram of a starting device having a case according to the present disclosure.

FIG. 2 is a sectional view of the case for the starting device according to the present disclosure.

FIG. 3 is a sectional view illustrating a manufacturing step for the case for the starting device according to the present disclosure.

FIG. 4 is a sectional view illustrating a manufacturing step for the case for the starting device according to the present disclosure.

FIG. 5 is a sectional view illustrating a manufacturing step for the case for the starting device according to the present disclosure.

FIG. 6 is a sectional view illustrating a manufacturing step for the case for the starting device according to the present disclosure.

FIG. 7 is a sectional view illustrating a manufacturing step for the case for the starting device according to the present disclosure.

FIG. 8 is a sectional view illustrating a manufacturing step for the case for the starting device according to the present disclosure.

FIG. 9 is a sectional view illustrating a manufacturing step for the case for the starting device according to the present disclosure.

FIG. 10 is a sectional view illustrating a manufacturing step for the case for the starting device according to the present disclosure.

FIG. 11 is an enlarged sectional view of a case for a starting device according to a comparative example.

FIG. 12 is an enlarged sectional view of the case for the starting device according to the comparative example.

FIG. 13 is an enlarged sectional view of the case for the starting device according to the present disclosure.

FIG. 14 is an enlarged sectional view of the case for the starting device according to the present disclosure.

FIG. 15 is an enlarged sectional view of a starting device according to a modification of the present disclosure.

### DETAILED DESCRIPTION

Next, an embodiment of present disclosure is described with reference to the drawings.

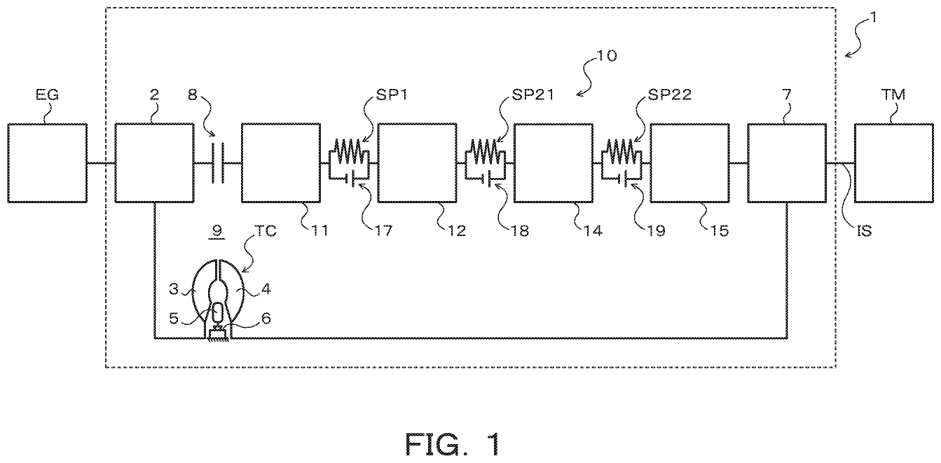

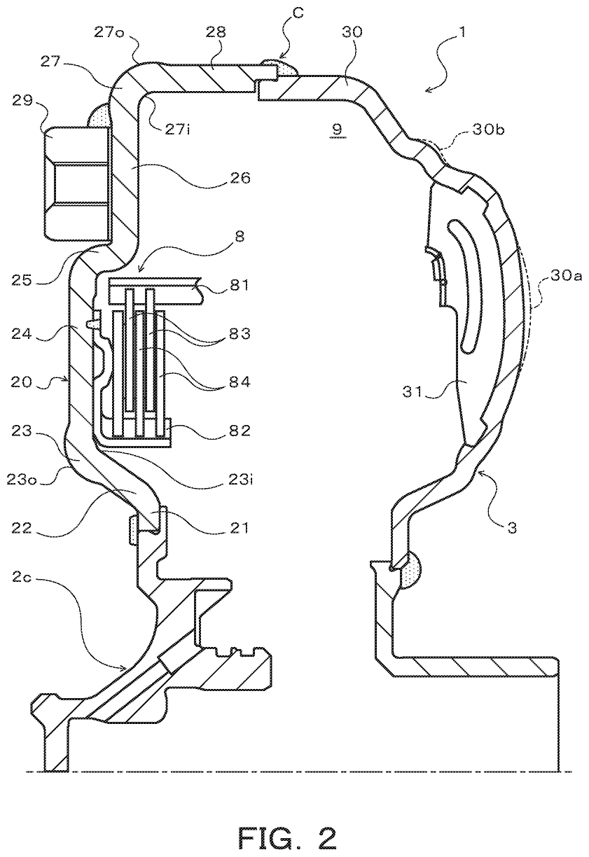

FIG. 1 is a schematic diagram of a starting device 1 having a case C according to the present disclosure, and FIG. 2 is a cross-sectional view of a main portion of the starting device 1 according to the present disclosure. The starting device 1 illustrated in these drawings is configured to be mounted on a vehicle that includes a motor such as an engine (an internal combustion engine) EG or an electric motor. As illustrated in the drawings, the starting device 1 includes the following: a front cover 2 as an input member that is coupled to an output shaft of the engine EG or the like and to which torque is transmitted from the engine EG or the like; a pump impeller (an input-side fluid transmission element) 3 fixed to the front cover 2; a torque converter TC including a turbine runner (an output-side fluid transmission element) 4 rotatable coaxially with the pump impeller 3, and a stator 5; a damper hub 7 as an output member fixed to an input shaft IS of a transmission TM such as an automatic transmission (AT) or a continuously variable transmission (CVT); a lockup clutch 8; and a damper device 10 coupled to the damper hub 7.

As illustrated in FIG. 2, the front cover 2 structures the case C for the starting device 1 and includes the following: an annular cover body 20 formed by press working from a metal sheet material (e.g., a cold rolled steel sheet); and a metal center piece 2c jointed (welded) to an inner peripheral portion of the cover body 20. The cover body 20 includes an inner peripheral portion 21, an inner inclined wall portion 22, an annular curved rib portion 23, a middle annular wall portion 24, a middle tubular portion 25, an outer annular wall portion 26, an annular corner portion 27, and an outer tube portion 28.

The inner peripheral portion 21 of the cover body 20 extends in a radial direction of the starting device 1 (in a direction perpendicular to an axis). The inner inclined wall portion 22 extends obliquely outward with respect to the radial direction, from the inner peripheral portion 21 toward the engine EG (to the left in FIG. 2). The curved rib portion 23 is a curved portion that is located on an inner peripheral side of the case C and that is located toward the engine EG. The curved rib portion 23 includes an outer surface 23o as an annular convexly-curved surface, and an inner surface 23i as an annular concavely-curved surface. The middle annular wall portion 24 connects to the inner inclined wall portion 22 via the curved rib portion 23 and extends outward from the curved rib portion 23 in the radial direction. The middle tubular portion 25 is a short tubular portion extending from the middle annular wall portion 24 in a direction away from the engine EG, i.e., in a direction toward the transmission TM (to the right in FIG. 2). The outer annular wall portion 26 connects to the middle tubular portion 25 and extends outward from the middle tubular portion 25 in the radial direction. Multiple set blocks 29 that are used for coupling to the output shaft of the engine EG or the like are fixed (welded) to the outer annular wall portion 26 at circumferential intervals. The corner portion 27 is a curved portion that is located on an outermost peripheral side of the case C and that is located toward the engine EG. The corner portion 27 includes an outer surface 27o as an annular convexly-curved surface, and an inner surface 27i as an annular concavely-curved surface. The outer tube portion 28 connects to the outer annular wall portion 26 via the corner portion 27 and extends in an axial direction of the starting device 1 from the corner portion 27 toward the transmission TM.

According to the present embodiment, the inner peripheral portion 21, the inner inclined wall portion 22, the middle annular wall portion 24, the middle tubular portion 25, the outer annular wall portion 26, and the outer tube portion 28 are formed to have a substantially equal thickness (t), except portions thereof that have been subjected to grinding or the like so as to adjust the weight balance or so as to weld other members thereto. In contrast, the curved rib portion 23 and the corner portion 27 are formed to have wall thicknesses greater than those of the inner peripheral portion 21, the inner inclined wall portion 22, the middle annular wall portion 24, the middle tubular portion 25, the outer annular wall portion 26, and the outer tube portion 28. That is, the thickness of the curved rib portion 23 gradually increases with increasing distance from a border with the inner inclined wall portion 22, becomes maximum near a vertex portion of the outer surface 23o, and gradually decreases with decreasing distance to a border with the middle annular wall portion 24. The thickness of the corner portion 27 gradually increases with increasing distance from a border with the outer annular wall portion 26, becomes maximum near a vertex portion of the outer surface 27o, and gradually decreases with decreasing distance to a border with the outer tube portion 28.

The pump impeller 3 of the torque converter TC includes a pump shell 30 and multiple pump blades 31 that are mounted on an inner surface of the pump shell 30. The pump shell 30 is hermetically fixed (welded) to a free end of the outer tube portion 28 of the cover body 20 and works in conjunction with the front cover 2 to structure the case C for the starting device 1. An oil chamber 9 is defined in the interior of the case C, and hydraulic oil (hydraulic fluid) is supplied into the oil chamber 9 from a hydraulic pressure control unit, which is not illustrated in the drawings. The turbine runner 4 includes the following: a turbine shell, which is not illustrated in the drawings, fixed to the damper hub 7 via multiple rivets; and multiple turbine blades (illustration thereof is omitted) that are disposed on an inner surface of the turbine shell. The stator 5 is mounted coaxially with and between the pump impeller 3 and the turbine runner 4 that face toward each other. The stator 5 adjusts the flow of hydraulic oil from the turbine runner 4 to the pump impeller 3, thereby amplifying torque. The pump impeller 3, the turbine runner 4, and the stator 5 form a torus (an annular flow passage) that circulates hydraulic oil.

A rotation direction of the stator 5 is limited by a one-way clutch 6 to one direction, i.e., the same direction as the direction in which the pump impeller 3 and the turbine runner 4 rotate. When a velocity ratio of the torque converter TC (the number of rotations of the turbine runner 4/the number of rotations of the pump impeller 3) is large, the stator 5 rotates with rotation of the pump impeller 3 and the turbine runner 4. In contrast, when the velocity ratio becomes small, the rotation of the stator 5 is limited by the action of the one-way clutch 6 so that hydraulic oil from the turbine runner 4 is adjusted by the stator 5 and is returned to the pump impeller 3. This makes it possible to increase a torque ratio of the torque converter TC (output torque / input torque).

The lockup clutch 8 performs lockup that couples together the front cover 2 and the damper hub 7 via the damper device 10, and also releases the lockup. According to the present embodiment, the lockup clutch 8 is a hydraulic multi-plate clutch and, as illustrated in FIG. 2, includes the following: a lockup piston, which is not illustrated in the drawings, axially movably supported by the center piece 2c of the front cover 2; a clutch drum 81; an annular clutch hub 82 fixed to an inner surface of the middle annular wall portion 24 of the front cover 2 (the cover body 20); multiple first frictionally-engaging plates (friction plates each with a friction material on both sides) 83 that are fitted with splines formed on an inner periphery of the clutch drum 81; and multiple second frictionally-engaging plates (separator plates) 84 that are fitted with splines formed on an outer periphery of the clutch hub 82. Alternatively, the lockup clutch 8 may be a hydraulic single-plate clutch that includes a lockup piston with a friction material bonded thereto.

As illustrated in FIG. 1, the damper device 10 includes the following: a drive member (an input element) 11, as a rotation element, coupled to the clutch drum 81; a first intermediate member (a first intermediate element) 12; a second intermediate member (a second intermediate element) 14; and a driven member (an output element) 15 coupled to the damper hub 7. Further, the damper device 10 includes, as torque transmission elements (torque transmission elastic bodies), the following, for example: multiple outer springs (first elastic bodies) SP1 disposed proximate to an outer periphery of the damper device 10; and equal numbers of multiple first inner springs (second elastic bodies) SP21 and multiple second inner springs (third elastic bodies) SP22 disposed on an inner side with respect to the outer springs SP1, Further, the damper device 10 includes the following, as stoppers that restrict relative rotation between the drive member 11 and the driven member 15: a first stopper 17 that restricts relative rotation between the drive member 11 and the first intermediate member 12; a second stopper 18 that restricts relative rotation between the first intermediate member 12 and the second. intermediate member 14; and a third stopper 19 that restricts relative rotation between the second intermediate member 14 and the driven member 15. However, the damper device 10 in the starting device 1 is not limited to this structure. Further, the damper device 10 may include a dynamic damper that is coupled via an elastic body to any of the drive member 11, the first intermediate member 12, the second intermediate member 14, and the driven member 15.

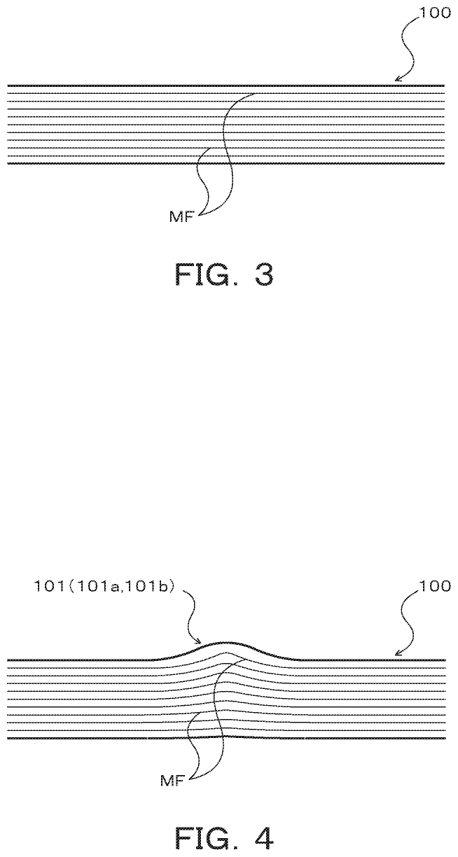

Next, manufacturing steps for the cover body 20 of the front cover 2 included in the case C for the starting device 1 are described. The cover body 20 is formed by press working from a metal sheet material 100, like the one illustrated in FIG. 3, that has a uniform thickness and in which metal flows MF are nearly parallel to front and back sides of the sheet material 100. Before the inner peripheral portion 21, the inner inclined wall portion 22, the curved rib portion 23, the middle annular wall portion 24, the middle tubular portion 25, the outer annular wall portion 26, the corner portion 27, and the outer tube portion 28 are formed by press working, at least one (two, according to the present embodiment) annular thickened portion 101 is formed on the sheet material 100 by partially thickening the sheet material 100 by press working, as illustrated in FIG. 4.

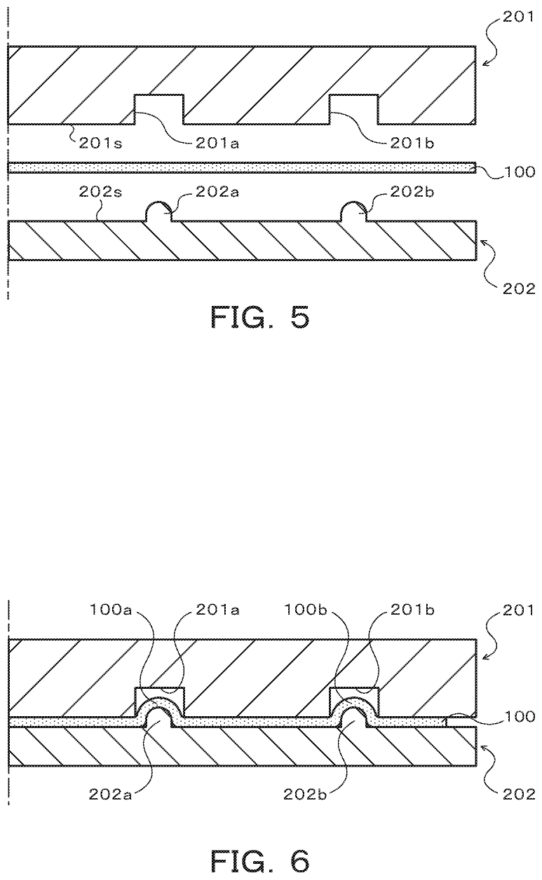

For example, when two annular thickened portions 101 are formed on the sheet material 100, a first upper die 201 and a first lower die 202, like those illustrated in FIG. 5, which are, for example, respectively a movable die and a stationary die, are brought close to each other. Thus, as illustrated in FIG. 6, two annular projecting portions, namely, a first annular projecting portion 100a and a second annular projecting portion 100b are concentrically formed on a disc-shaped metal sheet material 100 such that they each project from one side of the sheet material 100.

As illustrated in the drawings, the first upper die 201 includes a flat forming surface 201s, a first forming recess 201a having an annular shape about an axis of the first upper die 201, and a second forming recess 201h having an annular shape about the axis of the first upper die 201. The first forming recess 201a is recessed from the forming surface 201s on an axis side of the first upper die 201, and the second. forming recess 201b is recessed from the forming surface 201s on an outer peripheral side of the first upper die 201. As illustrated in the drawings, the first lower die 202 includes a flat forming surface 202s, a first forming projection 202a having an annular shape about an axis of the first die 202, and a second forming projection 202b having an annular shape about the axis of the first lower die 202.

The first forming projection 202a projects from the forming surface 202s on an axis side of the first lower die 202, and the second forming projection 202b projects from the forming surface 202s on an outer peripheral side of the first lower die 202. An inside diameter of the first forming projection 202a is larger than an inside diameter of the first forming recess 201a of the first upper die 201, an outside diameter of the first forming projection 202a. is smaller than an outside diameter of the first forming recess 201a, and a height of the first forming projection 202a is smaller than a depth of the first forming recess 201a. An inside diameter of the second forming projection 202b is larger than an inside diameter of the second forming recess 201b of the first upper die 201, an outside diameter of the second forming projection 202b is smaller than an outside diameter of the second forming recess 201b, and a height of the second forming projection 202b is smaller than a depth of the second forming recess 201b. Further, tips of the first and second forming projections 202a and 202b are formed to have a semicircular cross section.

By bringing the first upper die 201 and the first lower die 202 close to each other ith the disc-shaped metal sheet material 100 disposed between the first upper die 201 and the first lower die 202, a portion of the sheet material 100 compressed by the first forming projection 202a of the first lower die 202 enters the first forming recess 201a of the first upper die 201 while a portion of the sheet material 100 compressed by the second forming projection 202b of the first lower die 202 enters the second forming recess 201b of the first upper die 201. Thus, the first annular projecting portion 100a is formed on the center side of the sheet material 100, while the second annular projecting portion 100b is formed on an outer peripheral side of the sheet material 100. Alternatively, the first upper die 201 and the first lower die 202 may be interchanged in vertical position.

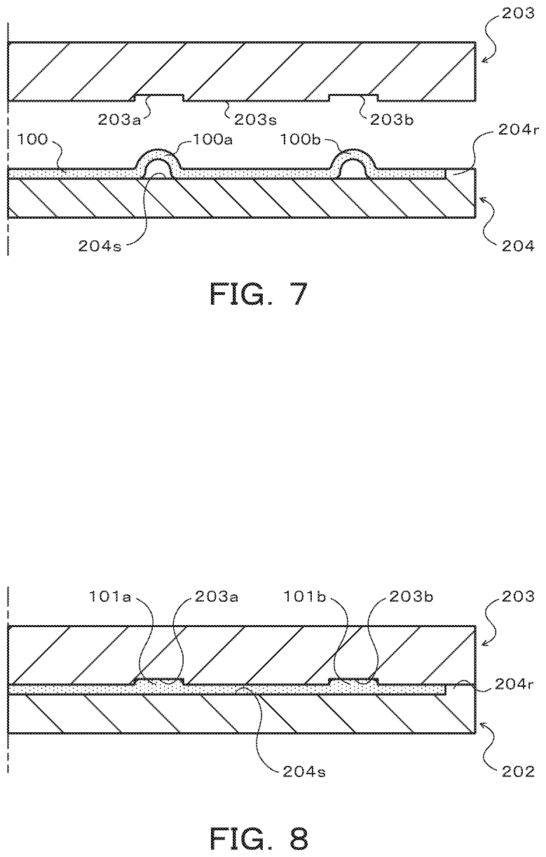

Next, a second upper die 203 and a second lower die 204, like those illustrated in FIG. 7, which are, for example, respectively a movable die and a stationary die, are brought close to each oilier. Thus, as illustrated in FIG. 8, two thickened portions, namely, a first thickened portion 101a and a second thickened portion 101b are concentrically formed on the sheet material 100 such that they each project from one side of the sheet material 100.

As illustrated in the drawings, the second upper die 203 includes a flat forming surface 203s, a first forming recess 203a having an annular shape about an axis of the second upper die 203, and a second forming recess 203b having an annular shape about the axis of the second upper die 203. The first forming recess 203a is recessed from the forming surface 203s on the axis side of the second upper die 203, and the second forming recess 203b is recessed from the forming surface 203s on an outer peripheral side of the second upper die 203. The depth of the first forming recess 203a is smaller than the depth of the first forming recess 201a of the first upper die 201, and the depth of the second forming recess 203b is smaller than the depth of the second forming recess 201b of the first upper die 201. Further, the radial width (a difference between the outside and inside diameters) of the first forming recess 203a is slightly larger than the radial width (a difference:between the outside and inside diameters) of the first forming recess 201a of the first upper die 201, and the radial width (a difference between the outside and inside diameters) of the second forming recess 203b is slightly larger than the radial width (a difference between the outside and inside diameters) of the second forming recess 201b of the first upper die 201. As illustrated in the drawings, the second lower die 204 includes a flat circular forming surface 204s and a diameter-increase restriction portion 204r that is annular in shape and that is formed around the forming surface 204s. The diameter-increase restriction portion 204r projects beyond the forming surface 204s upward in the drawings and has a flat surface.

When the first thickened portion 101a and the second thickened portion 101b are formed, the sheet material 100 having the first and second annular projecting portions 100a and 100b formed thereto is disposed between the second upper die 203 and the second lower die 204, and then the second upper die 203 and the second lower die 204 are brought close to each other, with the diameter-increase restriction portion 204r restricting movement of an outer periphery of the sheet material 100, i.e., an increase in the diameter of the sheet material 100. This causes metal that forms the first annular projecting portion 100a of the sheet material 100 to be compressed by a bottom surface of the first forming recess 203a of the second upper die 203 and thus to flow into the first forming recess 203a and toward the forming surface 204s of the second lower die 204, while causing metal that forms the second annular projecting portion 100b of the sheet material 100 to be compressed by a bottom surface of the second forming recess 203b of the second upper die 203 and thus to flow into the second forming recess 203b and toward the forming surface 204s of the second lower die 204. As a result, as illustrated in FIG. 8, the first thickened portion 101a is formed on the center side of the sheet material 100, and the second thickened portion 101b is formed on the outer peripheral side of the sheet material 100. Alternatively, the second upper die 203 and the second lower die 204 may be interchanged in vertical position. Further, an annular forming recess that faces the first forming recess 203a of the second upper die 203, and an annular forming recess that faces the second forming recess 203b of the second upper die 203 may be formed in the second lower die 204.

The first and second thickened portions 101a and 101b eventually become the curved rib portion 23 and the corner portion 27. According to the present embodiment, the two annular first and second thickened portions 101a and 101b are concentrically formed on the sheet material 100. The first and second thickened portions 101a and 101h are formed to project from only one side (the top side in the drawings) of the sheet material 100 while the other side (the bottom side in the drawings) of the sheet material 100 remains almost flat. Further, the first and second thickened portions 101a and 101b may be each formed to have a thickness that becomes maximum at a middle portion (a vertex portion) thereof in a radial direction and that gradually decreases with increasing distance from the middle portion either inward or outward in the radial direction. Further, the first and second thickened portions 101a and 101b are formed without causing any dent on the other side (the bottom side in the drawings), so that metal flows MF are continuous from the one side to the other side (including both sides) without any break (refer to FIG. 4). Further, curvatures of the metal flows MF in the first and second thickened portions 101a and 101b decrease from the other side to the one side.

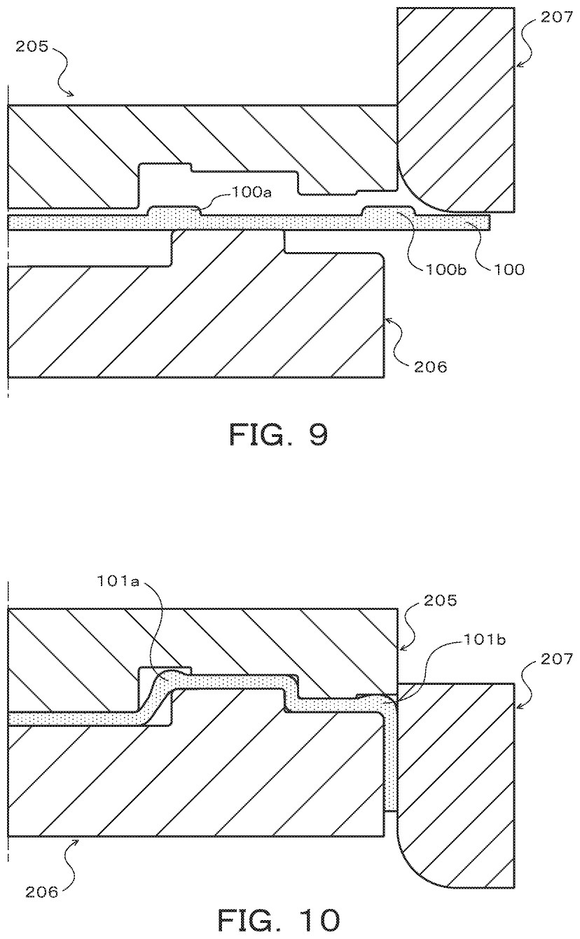

Then, press working is performed as illustrated in FIG. 9 on the sheet material 100 having the first and second thickened portions 101a and 101b, thereby forming the cover body 20 having the inner peripheral portion 21, the inner inclined wall portion 22, the curved rib portion 23, the middle annular wall portion 24, the middle tubular portion 25, the outer annular wall portion 26, the corner portion 27, and the outer tube portion 28. In this press working, the sheet material 100 is bent at multiple bending locations including the first and second thickened portions 101a and 101b, by using an upper die punch 205, a lower die punch 206, and an annular drawing die 207 like those illustrated in FIG. 10. This makes it possible to obtain the curved rib portion 23 and the corner portion 27 that are greater in wall thickness than the inner peripheral portion 21, the inner inclined wall portion 22, the middle annular wall portion 24, the middle tubular portion 25, the outer annular wall portion 26, and the outer tube portion 28. That is, bending the sheet material 100 at the first thickened portion 101a forms the curved rib portion 23 to the cover body 20, and bending the sheet material 100 at the second thickened portion 101b forms the corner portion 2.7 to the cover body 20.

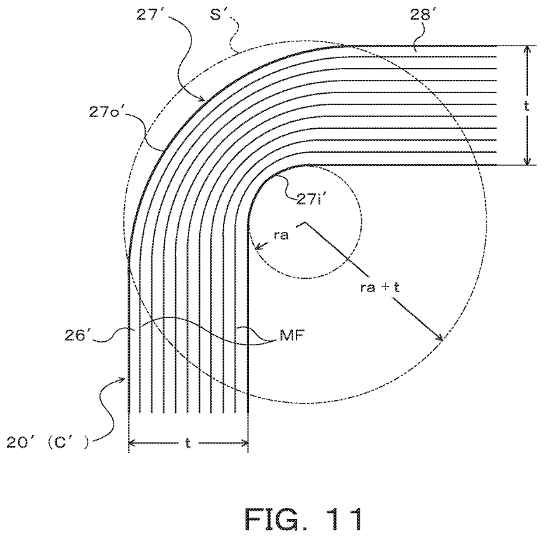

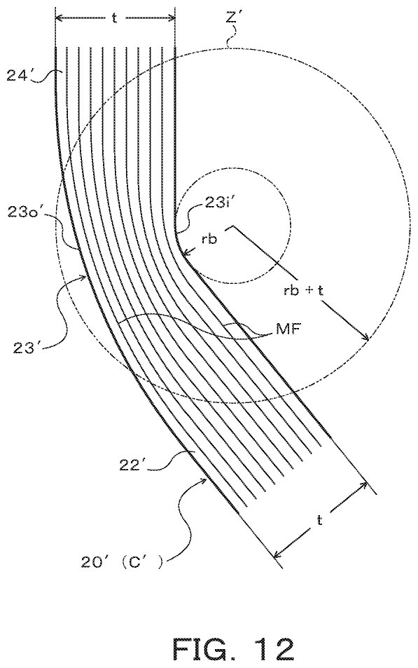

Here, FIG. 11 illustrates an outer annular wall portion 26′, a corner portion 27′, and an outer tube portion 28′ of a cover body 20′ formed by press working from a sheet material 100 that has a thickness t and that does not have any of the thickened portions 101. Further, FIG. 12 illustrates an inner inclined wall portion 22′, a curved rib portion 23′, and a middle annular wall portion 24′ of the cover body 20′ formed. by press working from the sheet material 100 that has the thickness t and that does not have any of the thickened portions 101. The cover body 20′ is basically identical in specification to the cover body 20, except the curved rib portion 23′ and the corner portion 27′.

As illustrated in FIG. 11, a dent does not occur on an inner surface 27i′ of the corner portion 27′, so that metal flows ME in the corner portion 27′ are continuous from the inner surface 27i to an outer surface 27o without any break. However, at the corner portion 27′, the outer surface 27o′ is bowed inward of a case C′ more than a curved surface S′. The curved surface S′ has a radius of curvature equal to the sum (ra+t) of a radius of curvature ra of the inner surface 27i′ and the thickness t, and is concentric with the inner surface 27i′ on a plane that includes an axis of the starting device 1. Further, the radius of curvature of the outer surface 27o′ of the corner portion 27′ is larger than the sum (ra+t) of the radius of curvature ra of the inner surface 27i′ of the corner portion 27′ and the thickness t. For this reason, as illustrated in FIG. 11, the corner portion 27′ becomes smaller in wall thickness than the outer annular wall portion 26′ and the outer tube portion 28′.

Further, as illustrated in FIG. 12, a dent does not occur on an inner surface 23i′ of the curved rib portion 23′, so that metal flows MF in the curved rib portion 23′ are also continuous from the inner surface 23i to an outer surface 23o without any break. However, at the curved rib portion 23′, the outer surface 23o′ is bowed inward of the case C′ more than a curved surface Z′. The curved surface Z′ has a radius of curvature equal to the sum (rb+t) of a radius of curvature rb of the inner surface 23i′ and the thickness t, and is concentric with the inner surface 23i′ on a plane that includes the axis of the starting device 1. Further, the radius of curvature of the outer surface 23o′ of the curved rib portion 23′ is larger than the sum (rb+t) of the radius of curvature rb of the inner surface 23i′ of the curved rib portion 23′ and the thickness t. Thus, as illustrated in FIG. 12, the curved rib portion 23′ also becomes smaller in wall thickness than the inner inclined wall portion 22′ and the middle annular wall portion 24′.

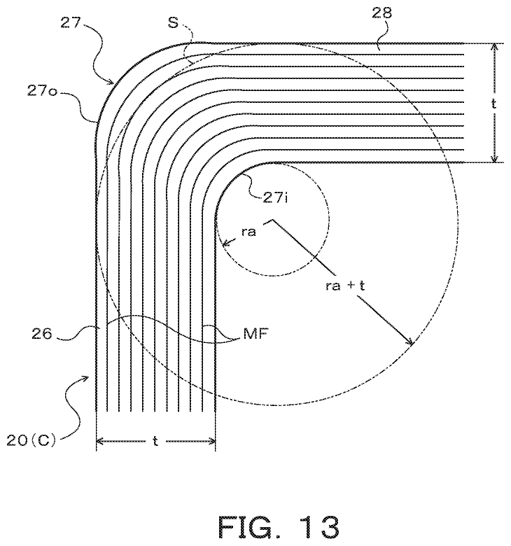

In contrast, at the corner portion 27 that is formed by bending the sheet material 100 at the thickened portion 101 by press working, as illustrated in FIG. 13, the outer surface 27o projects outward of the case C′ beyond a curved surface S. The curved surface S has a radius of curvature equal to the sum (ra+t) of a radius of curvature ra of the inner surface 27i and the thickness (the minimum thickness) t of the sheet material 100 (part without the thickened portion 101), and is concentric with the inner surface 27i on a plane that includes the axis of the starting device 1. Further, as can be seen from FIG. 13, the radius of curvature of the outer surface 27o of the corner portion 27 is smaller than the sum (ra+t) of the radius of curvature ra of the inner surface 27i of the corner portion 27 and the thickness t. Furthermore, the degree by which the curvatures of the metal flows ME in the corner portion 27 increase in a direction from the inner surface 27i to the outer surface 27o is small compared to in the corner portion 27′ of the cover body 20′ that is formed by bending a portion of the sheet material 100 where the thickness t is uniform.

In this way, bending the sheet material 100 at the thickened portion 101 by press working causes the outer surface 27o of the corner portion 27 to project beyond the curved surface S so as to thicken the corner portion 27. This allows the corner portion 27 to serve as a rib, thus increasing the stiffness of the case C for the starting device 1 to which torque is transmitted from the engine EG and to which centrifugal hydraulic pressure is applied. Further, a dent does not occur on the inner surface 27i of the corner portion 27, so that metal flows MF in the corner portion 27 are continuous from the inner surface 27i to the outer surface 27o (including the inner surface 27i and the outer surface 27o) without any break. That is, since the corner portion 27 is formed by thickening only a necessary portion of the cover body 20 (the case C), without performing grinding that causes an increase in cost, the corner portion 27 itself has high stiffness.

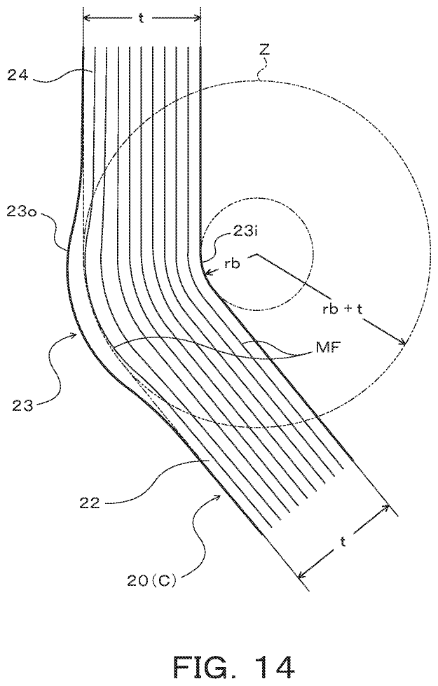

Further, at the curved rib portion 23 that is formed by bending the sheet material 100 at the thickened portion 101 by press working, as illustrated in FIG. 14, the outer surface 23o projects outward of the case C′ beyond a curved surface Z. The curved surface Z has a radius of curvature equal to the sum (rb+t) of a radius of curvature rb of the inner surface 23i and the thickness t of the sheet material 100 (part without the thickened portion 101), and is concentric with the inner surface 23i on a plane that includes the axis of the starting device 1. Further, the radius of curvature of the outer surface 23o of the curved rib portion 23 is smaller than the sum (rb+t) of the radius of curvature rb of the inner surface 23i of the curved rib portion 23 and the thickness t. as can be seen in FIG. 14.

That is, in the starting device 1, the outer surface 23o of the curved rib portion 23 is caused to project beyond the curved surface Z so as to thicken the curved rib portion :23, in addition to the corner portion 27. This allows the curved rib portion 23 to serve as a rib, thus increasing the stiffness of the case C for the starting device 1 to which torque is transmitted from the engine EG and to which centrifugal hydraulic pressure is applied. Further, jamming does not occur on the inner surface 23i of the curved rib portion 23, so that metal flows MF in the curved rib portion 23 are continuous from the inner surface 23i to the outer surface 23o (including the inner surface 23i and the outer surface 23o) without any break. That is, since the curved rib portion 23 is also formed by thickening only a necessary portion of the cover body 20 (the case C), without performing grinding that causes an increase in cost, the curved rib portion 23 itself has high stiffness.

Therefore, the starting device 1 in which the cover body 20 of the front cover 2 (the case C) is provided with the corner portion 27 and the curved rib portion 23 is capable of inhibiting not only deformation of a radially outer portion of the case C to be subjected to more centrifugal hydraulic pressure but also deformation of a radially inner portion of the case C, thus inhibiting so-called ballooning effectively. Further, this makes it possible to select the thickness t of the sheet material 100 that forms the front cover 2 (the case C) according to portions that do not require high stiffness, and thus to restrain an increase in cost and an increase in weight of the case C. Therefore, in the starting device 1, it is possible to increase the stiffness of the case C (the front cover)more effectively while restraining increases in weight and cost. Further, making the radius of curvature of the outer surface 27o of the corner portion 27 smaller than the sum of the radius of curvature ra of the inner surface 27i and the thickness t of the sheet material 100 allows the corner portion 27 to be further thickened without any break in the metal flows MF from the inner surface 27i to the outer surface 27o. Further, making the radius of curvature of the outer surface 23o of the curved rib portion 23 smaller than the sum of the radius of curvature rb of the inner surface 23i and the thickness t of the sheet material 100 allows the curved rib portion 23 to be further thickened without any break in the metal flows Mb from the inner surface 23i to the outer surface 23o.

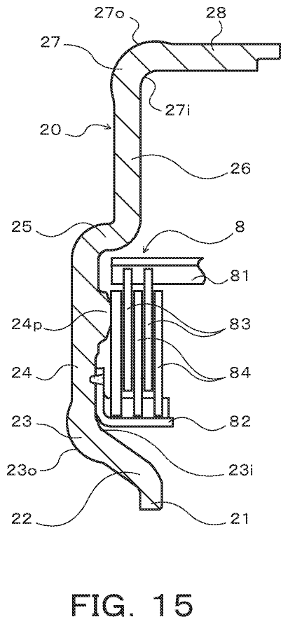

It is noted that only any one of the corner portion 27 and the curved rib portion 23 may be formed on the cover body 20 by bending the sheet material 100 at the thickened portion 101 by press working. Further, the cover body 20 may be provided with three or more thickened curved portions like the corner portion 27 and the curved rib portion 23. Furthermore, as illustrated in FIG. 15, the thickened portion 101 may be utilized to form a protrusion 24p to the middle annular wall portion 24 of the cover body 20. This allows omission of a parking plate (an end plate) from the lockup clutch 8 so as to reduce the number of parts while further increasing the strength of the front cover 2 (the case C). Further, thickened curved portions like the corner portion 27 and the curved rib portion23 may be formed on oil chamber defining members such as a piston, clutch drum, and a clutch hub of a single-plate or multi-plate clutch.

Furthermore, the pump shell 30 that structures the case C for the starting device 1 with the front cover 2 may be formed by press working from a sheet material having, for example, two annular thickened portions formed thereto, in the same manner as illustrated in FIG. 9 and FIG. 10. In this case, as indicated by a long dashed double-short dashed line in FIG. 2, a thickened portion 30a may be formed on the pump shell 30 by bending the sheet material at the thickened portion on the center side, and a curved rib portion 30h may be formed on the pump shell 30 by bending the sheet material at the thickened portion on the outer peripheral side. The thickened portion 30a is located behind radially middle portions of the pump blades 31, and the curved rib portion 30h is located behind radially outer ends of the pump blades 31. Forming the thickened portion 30a and the curved rib portion 30b to the pump shell 30 makes it possible to inhibit the ballooning more effectively.

Further, although FIGS. 5 to 8 illustrate that multiple annular projecting portions, namely, the first and second annular projecting portions 100a and 100b are concentrically formed simultaneously to the sheet material 100 that is disc-shaped, and then the first and second thickened portions 101a, 101b that are each annular in shape are formed by compressing the first and second annular projecting portions 100a, 100b while restricting an increase in diameter of the sheet material 100, steps of forming annular projecting portions and thickened portions to a sheet material are not limited to this. That is, multiple annular projecting portions may he concentrically formed on a disc-shaped sheet material sequentially in order from the innermost one, and then multiple annular thickened portions may be formed on the sheet material by compressing the multiple annular projecting portions. This makes it possible to increase the height (the amount of projection) of the annular projecting portion so as to further thicken the annular thickened portion.

As described above, a method of manufacturing a case for a starting device according to the present disclosure is a method of manufacturing a case (C) for a starting device (1) that has at least one curved portion (23, 27) and that has an interior (9) configured to be supplied with oil, and includes the following: forming a thickened portion (101, 101a, 101b) by partially thickening a metal sheet material (100); and forming the curved portion (23, 27) of the case (C) by bending the sheet material (100) at the thickened portion (101, 101a, 101b) by press working.

The method according to the present disclosure is capable of forming the curved portion of the case for the starting device such that the outer surface projects outward of the case beyond a curved surface that is concentric with an inner surface of the curved portion and that has a radius of curvature equal to the sum of the radius of curvature of the inner surface and the thickness of the sheet material forming the case, and such that metal flows are continuous from the inner surface to the outer surface without any break. This allows the curved portion to be thickened so as to serve as a rib, without performing grinding that causes an increase in cost, thus increasing the stiffness of the case for the starting device to which torque is transmitted from a motor and to which centrifugal hydraulic pressure is applied. This makes it possible to select the thickness of the sheet material that forms the case according to portions that do not require high stiffness, and thus to restrain an increase in cost and an increase in weight of the case. Therefore, it is possible to increase the stiffness of the case for the starting device while restraining increases in the weight and cost.

Further, after an annular projecting portion (100a, 100b) is formed on the sheet material (100), the thickened portion (101a, 101b) may be formed on the sheet material (100) by compressing the annular projecting portion (100a, 100b).

Furthermore, the sheet material (100) may be disposed between a first forming die (201) having an annular forming recess (201a, 201b) and a second forming die (202) having an annular forming projection (202a, 202b), and the annular projecting portion (100a, 100b) may be formed on the sheet material (100) by bringing the first forming die (201) and the second forming die (202) close to each other.

Further, the thickened portion (101a, 101b) may he formed on the sheet material (100) by compressing the annular projecting portion (100a, 100b) using a third forming die (203) having an annular forming recess (203a, 203b) and a fourth forming die (204) having a restriction portion (204r) that restricts movement of an outer periphery of the sheet material (100).

Furthermore, after a plurality of the annular projecting portions (100a, 100b) is concentrically formed on the sheet material (100) that is disc-shaped, a plurality of the thickened portions (101a, 101b) each annular in shape may he formed on the sheet material (100) by compressing the plurality of the annular projecting portions (100a, 100b) while restricting an increase in diameter of the sheet material (100).

Further, a plurality of the annular projecting portions (100a, 100b) may be concentrically formed on the sheet material (100) that is disc-shaped, sequentially in order from the innermost one, and a plurality of the thickened portions (101a, 101b) each annular in shape may be formed on the sheet material (100) by compressing the plurality of the annular projecting portions (100a, 100b).

Furthermore, an annular first thickened portion (101a) may be formed on the center side of the sheet material (100) while an annular second thickened portion (101b) may be formed on an outer peripheral side of the sheet material (100), and a rib portion (23) that is located on an inner peripheral side of the case (C) and that is located toward a motor (EG) coupled to the starting device (1) may be formed by bending the sheet material (100) at the first thickened portion (101a), while a corner portion (27) that is located on an outermost peripheral side of the case (C) and that is located toward the motor (EG) coupled to the starting device (1) may be formed by bending the sheet material (100) at the second thickened portion (101b).

A case for a starting device according to the present disclosure is a case (C) for a starting device (1) that is formed from a metal sheet material (100), that has at least one curved portion (23, 27), and that has an interior (9) configured to be supplied with oil, wherein an outer surface (23o, 270) of the curved portion (23, 27) projects outward of the case (C) beyond a curved surface (S, Z) that is concentric with an inner surface (27i) of the curved portion (23, 27) and that has a radius of curvature equal to the sum of the radius of curvature (ra, rb) of the inner surface (23i, 27i) and the thickness (t) of the sheet material (100) forming the case (C), and metal flows (MF) in the curved portion (23, 27) are continuous from the inner surface (23i, 27i) to the outer surface (23o, 27o) without any break.

The curved portion included in the case for the starting device is thickened such that the outer surface projects outward of the case beyond the curved surface that is concentric with the inner surface of the curved portion and that has a radius of curvature equal to the sum of a radius of curvature of the inner surface and the thickness of the sheet material forming the case. This allows the curved portion to serve as a rib, thus increasing the stiffness of the case for the starting device to which torque is transmitted from a motor and to which centrifugal hydraulic pressure is applied. Further, the curved portion is formed such that metal flows are continuous from the inner surface to the outer surface without any break. That is, since the curved portion is formed by thickening only a necessary portion of the case, without performing grinding that causes an increase in cost, the curved portion itself has high stiffness. This makes it possible to select the thickness of the sheet material that forms the case according to portions that do not require high stiffness, and thus to restrain an increase in cost and an increase in weight of the case. Therefore, it is possible to increase the stiffness of the case for the starting device while restraining increases in the weight and cost.

Further, the radius of curvature of the outer surface (23o, 270) of the curved portion (23, 27) may be smaller than the sum of the radius of curvature (ra, rb) of the inner surface (23i, 27i) of the curved portion (23, 27) and the thickness (t) of the sheet material (100) forming the case (C). This allows the curved portion to be further thickened without any break in the metal flows from the inner surface to the outer surface.

Further, the degree by which the curvatures of the metal flows (MF) in the curved portion (23, 27) increase in a direction from the inner surface (23i, 27i) to the outer surface (23o, 27o) is small compared to in a curved portion (23′, 27′) that is farmed by bending a portion of the sheet material (100) where the thickness is uniform.

Further, the curved portion may include a corner portion (27) that is located on an outermost peripheral side of the case (C) and that is located toward a motor (EG) coupled to the starting device (1), and the curved portion may include a rib portion (23) that is located on an inner peripheral side of the case (C) and that is located toward the motor (EG) coupled to the starting device (1). This makes it possible to increase the stiffness of the case for the starting device more effectively while restraining increases in the weight and cost. Further, providing the case for the starting device with the corner portion and the curved rib portion makes it possible to inhibit not only deformation of a radially outer portion of the case to be subjected to larger centrifugal hydraulic pressure but also deformation of a radially inner portion of the case, thus inhibiting so-called ballooning effectively.

The invention according to the present disclosure is not limited at all to the embodiment described above, and various modifications are possible within the scope of the present disclosure. In addition, the embodiment of the invention is merely one specific example of the invention described in SUMMARY OF THE APPLICATION and does not limit the elements of the invention described in SUMMARY OF THE APPLICATION

### INDUSTRL APPLICABILITY

The aspects of the present disclosure are usable in the field of, for example, manufacturing of starting device.

1-12. (canceled)

13. A method of manufacturing a case for a starting device, the case having at least one curved portion and having an interior configured to be supplied with oil, the method comprising:
forming a thickened portion by partially thickening a metal sheet material; and
forming the curved portion by bending the sheet material at the thickened portion by press working.

14. The method of manufacturing a case for a starting device according to claim 13, wherein
after an annular projecting portion is formed on the sheet material, the thickened portion is formed on the sheet material by compressing the annular projecting portion.

15. The method of manufacturing a case for a starting device according to claim 14, wherein
the sheet material is disposed between a first forming die having an annular forming recess and a second forming die having an annular forming projection, and
the annular projecting portion is formed on the sheet material by bringing the first forming die and the second forming die close to each other.

16. The method of manufacturing a case for a starting device according to claim 14, wherein
the thickened portion is formed on the sheet material by compressing the annular projecting portion using a third forming die having an annular forming recess and a fourth forming die having a restriction portion that restricts movement of an outer periphery of the sheet material.

17. The method of manufacturing a case for a starting device according to claim 16, wherein
after a plurality of the annular projecting portions is concentrically formed on the sheet material that is disc-shaped, a plurality of the thickened portions each annular in shape are formed on the sheet material by compressing the plurality of the annular projecting portions while restricting an increase in diameter of the sheet material.

18. The method of manufacturing a case for a starting device according to claim 17, wherein
an annular first thickened portion is formed on a center side of the sheet material, while an annular second thickened portion is formed on an outer peripheral side of the sheet material, and
a rib portion that is located on an inner peripheral side of the case and that is located toward a motor coupled to the starting device is formed by bending the sheet material at the first thickened portion, while a corner portion that is located on an outermost peripheral side of the case and that is located toward the motor coupled to the starting device is formed by bending the sheet material at the second thickened portion.

19. The method of manufacturing a case for a starting device according to claim 16, wherein
a plurality of the annular projecting portions is concentrically formed on the sheet material that is disc-shaped, sequentially in order from an innermost one, and
a plurality of the thickened portions each annular in shape are formed on the sheet material by compressing the plurality of the annular projecting portions.

20. The method of manufacturing a case for a starting device according to claim 19, wherein
an annular first thickened portion is formed on a center side of the sheet material, while an annular second thickened portion is formed on an outer peripheral side of the sheet material, and
a rib portion that is located on an inner peripheral side of the case and that is located toward a motor coupled to the starting device is formed by bending the sheet material at the first thickened portion, while a corner portion that is located on an outermost peripheral side of the case and that is located toward the motor coupled to the starting device is formed by bending the sheet material at the second thickened portion.

21. A case for a starting device that is formed from a metal sheet material, that has at least one curved portion, and that has an interior configured to be supplied with oil, wherein
an outer surface of the curved portion projects outward of the case beyond a curved surface that is concentric with an inner surface of the curved portion and that has a radius of curvature equal to a sum of a radius of curvature of the inner surface and a thickness of the sheet material forming the case, and
metal flows in the curved portion are continuous from the inner surface to the outer surface without any break.

22. The case for a starting device according to claim 21, wherein
a radius of curvature of the outer surface of the curved portion is smaller than the sum of the radius of curvature of the inner surface of the curved portion and the thickness of the sheet material forming the case.

23. The case for a starting device according to claim 21, wherein
a degree by which curvatures of the metal flows in the curved portion increase in a direction from the inner surface to the outer surface is small compared to in a curved portion that is formed by bending a portion of the sheet material where the thickness is uniform.

24. The case for a starting device according to claim 21, wherein
the curved portion includes a corner portion that is located on an outermost peripheral side of the case and that is located toward a motor coupled to the starting device.

25. The case for a starting device according to claim 21, wherein
the curved portion includes a rib portion that is located on an inner peripheral side of the case and that is located toward a motor coupled to the starting device.
